(19) United States
(12) Patent Application Publication
(10) Pub. No.: US 2020/0332558 A1
(43) Pub. Date: Oct. 22, 2020

(54) MAGNETIC LOCK WITH FIXING STRUCTURE

(71) Applicant: Soyal Technology Co., Ltd., New Taipei City (TW)

(72) Inventor: Hung-Kun SHIH, New Taipei City (TW)

(73) Assignee: Soyal Technology Co., Ltd., New Taipei City (TW)

(21) Appl. No.: 16/828,910

(22) Filed: Mar. 24, 2020

(30) Foreign Application Priority Data
Apr. 17, 2019 (TW) 108113434

(51) Int. Cl. E05B 47/00

(52) U.S. Cl. CPC E05B 47/004; E05C 19/166

(57) ABSTRACT

A magnetic lock includes a housing, an electromagnetic body, a positioning member, and at least one clamp. The electromagnetic body can be received in a receiving space of the housing. The positioning member has a lateral side that is to abut against an outer lateral side of the housing. After the corresponding lateral sides of the positioning member and the housing are brought into abutment against each other, the clamp can be installed to clamp together an end edge of the positioning member and the adjacent end edge of the housing, and thereby fix the positioning member and the housing together. When installing elements between the housing and the positioning member break or are detached after long-term use, the clamp produces an additional or auxiliary fixing effect to ensure the safety of use of the magnetic lock.

### CROSS-REFERENCE TO RELATED PATENT APPLICATION

This non-provisional application claims priority to and the benefit of, under 35 U.S.C. § 119(a), Taiwan Patent Application No. 108113434, filed in Taiwan on Apr. 17, 2019. The entire content of the above identified application is incorporated herein by reference.

### FIELD

The present disclosure relates to a magnetic lock, and more particularly, to a magnetic lock whose housing and positioning member are fixed together by clamps.

### BACKGROUND

Doors, windows, cabinets, and so on are generally provided with locking devices to prevent unauthorized access and thereby ensure the safety of personal property. A sheerly mechanical lock can be cracked with tools (e.g., a master key) relatively easily. Electronic locks such as magnetic locks, keycard locks, electronic code locks, and wireless remote-controlled locks are gradually adopted for enhanced safety.

A magnetic lock, or electromagnetic lock to be exact, works on the principle of electrically induced magnetism. When supplied with electricity, a magnetic lock (e.g., one provided on a door frame) can attract and hold a mating armature plate (e.g., one provided on the door panel in the aforesaid door frame) and thus enter the locked state. When the power supply is cut off, the magnetic lock can no longer attract and hold the armature plate and is therefore in the unlocked state. Due to the lack of a complicated mechanical structure and a lock tongue, magnetic locks are suitable for use on emergency exit doors or fire doors for access control.

A conventional magnetic lock is typically composed of a housing and an electromagnetic body. The housing has a generally U-shaped cross section and forms a receiving space therein. The electromagnetic body at least includes an iron core and a coil. The iron core can be formed by welding together a plurality of silicon steel plates that are contiguously arranged, and the coil is wound around the iron core. When the electromagnetic body is supplied with electricity, a magnetic attraction force is generated on an outer surface of the electromagnetic body that is exposed through the housing.

The conventional magnetic locks, however, still have some inadequacies in use. First, it is common practice to fix the housing of a conventional magnetic lock to an external object (e.g., a door frame) through a positioning member. The positioning member, the housing, and electromagnetic body are locked to one another using a plurality of screws. When such a magnetic lock is in the locked state, the magnetic attraction force between the electromagnetic body and the mating armature plate can be viewed as a pulling force that tends to pull the electromagnetic body outward, i.e., out of the housing. This pulling force acts mainly on the contact points between the screws and the screw holes in the electromagnetic body, the housing, and the positioning member. If the contact points are subjected to a relatively large force, however, the housing may be deformed in the contact point areas. Consequently, the screws may also be damaged or even break, such that the positioning member and the housing are no longer securely assembled to each other. Should that happen, not only will the magnetic attraction force between the magnetic lock and the armature plate be reduced, but also the housing may be detached from the positioning member and fall off.

Second, the screw-based locking method mentioned above generally entails the use of a large number of screws and consequently a time-consuming assembly process.

The issue to be addressed by the present disclosure is to provide an effective solution to the foregoing inadequacies of the conventional magnetic locks so as to bring about better user experience.

### SUMMARY

In response to the above-referenced technical inadequacies associated with conventional magnetic locks, the present disclosure has culminated in the conception and development of a magnetic lock having a fixing structure. The present disclosure manifests years of practical experience in designing, processing, which, combined with long hours of research and experimentation, leads to such conception and development. The present disclosure is with the aim of overcoming the above-referenced technical inadequacies.

One aspect of the present disclosure is directed to a magnetic lock that has a fixing structure. The magnetic lock includes a housing that has a receiving space therein, an electromagnetic body, a positioning member and a clamp. The electromagnetic body can be assembled within the receiving space of the housing. A top surface of the electromagnetic body is exposed through the housing when the electromagnetic body is assembled within the receiving space. The electromagnetic body receives externally supplied electricity, and generates a magnetic attraction force on the top surface of the electromagnetic body. The positioning member can be fixed on an object, and has a first lateral side configured to abut against an outer lateral side of the housing. The clamp can, when the first lateral side of the positioning member abuts against the outer lateral side of the housing, clamp together an end edge of the positioning member and an adjacent end edge of the housing to fix the positioning member and the housing together. The provision of the clamp helps increase the safety of assembly and use of the magnetic lock by allowing the positioning member and the housing to be easily, rapidly, and securely fixed to each other.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is an exploded perspective view of the magnetic lock according to certain embodiments of the present disclosure.

FIG. 2 is an assembled perspective view of the magnetic lock.

FIG. 3 is a side view of an iron core according to certain embodiments of the present disclosure.

FIG. 4 is an exploded perspective partial view of the magnetic lock.

FIG. 5 is an assembled end view of the magnetic lock.

FIG. 6 is an exploded perspective partial view of the magnetic lock according to certain embodiments of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, parts or the like, which are for distinguishing one component/part from another one only, and are not intended to, nor should be construed to impose any substantive limitations on the components, parts or the like.

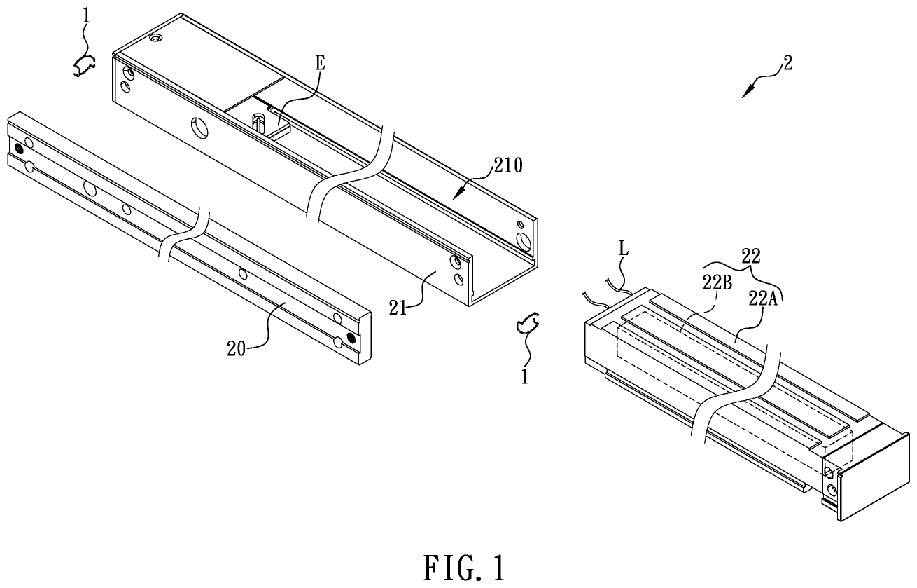

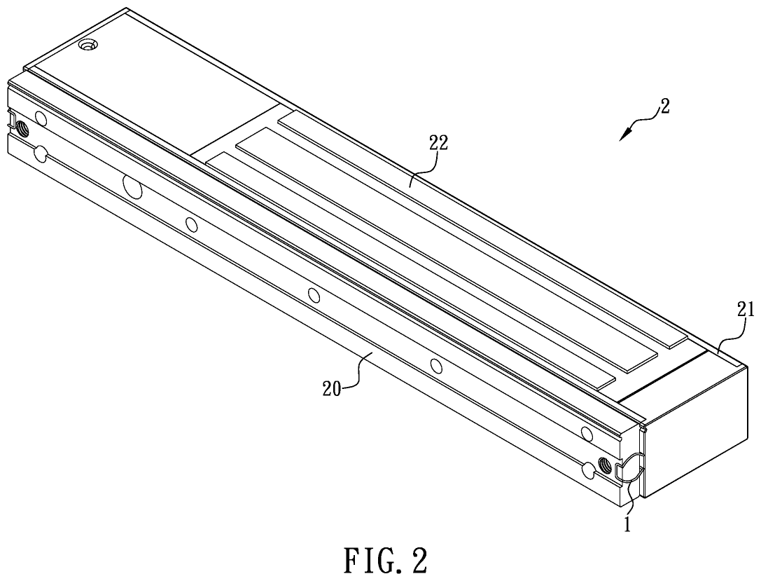

Referring to FIG. 1 and FIG. 2, a magnetic lock 2 provided by the present disclosure has a fixing structure. In certain embodiments, the magnetic lock 2 includes a positioning member 20, a housing 21, an electromagnetic body 22, and at least one clamp 1. To facilitate description, the top side of FIG. 1 is defined as corresponding to an upper side (e.g., top side) of each component, and the bottom side of FIG. 1 as corresponding to a lower side (e.g., bottom side) of each component. The foregoing directions, however, serve only to facilitate description of the positional relationships between components and do not limit the direction in which or the position at which the magnetic lock 2 is actually installed or used.

For the sake of simplicity, FIG. 1 shows only such additional components of the magnetic lock 2 as a circuit board E and a plurality of wires L. Regarding the circuit board E in the housing 21, the electromagnetic body 22 provided with the wires L, and the electromagnetic body 22 being electrically connected to the circuit board E and receiving externally supplied electricity through the wires L, a person skilled in the art who has read the following description shall be able to adjust the arrangement of the circuit board E and the wires L of the magnetic lock 2 as needed. All such adjustments do not depart from the scope of the present disclosure, provided that the magnetic lock 2 has the fixing structure and the related components described below.

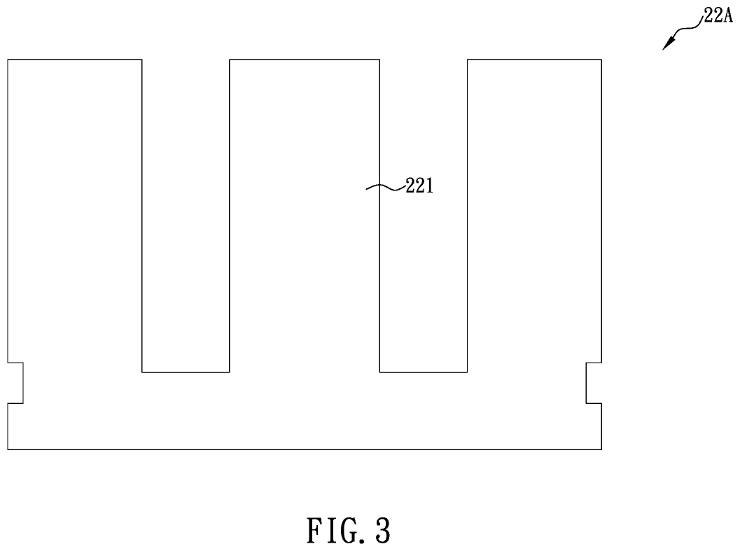

With continued reference to FIG. 1 and FIG. 2, the housing 21 has a generally U-shaped cross section, and is provided therein with a receiving space 210. The electromagnetic body 22 is configured to be assembled within the receiving space 210 of the housing 21, to receive externally supplied electricity, and to generate a magnetic attraction force on its exposed surface (e.g., the top surface as shown in FIG. 1). In certain embodiments, the electromagnetic body 22 includes an iron core 22A and a coil 22B. The iron core 22A may have an E-shaped cross section (see FIG. 3). In that case, the coil 22B may be wound around the middle post 221 of the iron core 22A either directly or indirectly (e.g., through a coil holder), in order for the iron core 22A to generate a magnetic attraction force when the coil 22B is supplied with electricity. The iron core 22A may be formed by a plurality of silicon steel plates that are stacked upon each other to combine into a strip structure, and by covering the iron core 22A and the coil 22B (or the coil holder) with a protective layer (e.g., epoxy resin, rubber, or the like) through which only the top end of the iron core 22A is exposed. The electromagnetic body 22 is not limited to the structure described above. In certain embodiments, the components of the electromagnetic body 22 and their configurations may be adjusted according to product requirements. Such an adjusted electromagnetic body still falls in the scope of the electromagnetic body 22 as defined in the present disclosure, as long as it can be assembled within the housing 21, can generate a magnetic attraction force when supplied with electricity, and stops generating the magnetic attraction force when the electricity supply ceases.

Referring again to FIG. 1 and FIG. 2, the positioning member 20 is configured to be fixed on an external object (e.g., a door frame). In certain embodiments, one lateral side of the positioning member 20 is configured to abut against an outer lateral side of the housing 21. The positioning member 20 and the housing 21 can be assembled to each other via at least one installing element (e.g., at least one screw or slide rail). When an armature plate is mounted on the door panel to whose door frame the positioning member 20 is fixed (i.e., on whose door frame the housing 21 and the electromagnetic body 22 are mounted), and when the magnetic lock 2 is supplied with electricity, the top surface of the electromagnetic body 22 (i.e., the top surface of the iron core 22A) can attract and hold the armature plate on the door panel, thus bringing the magnetic lock 2 into the locked state to prevent the door panel from opening. Once the supply of electricity is cut off from the magnetic lock 2, the electromagnetic body 22 can no longer attract and hold the armature plate, so the magnetic lock 2 is in the unlocked state and allows the door panel to be opened.

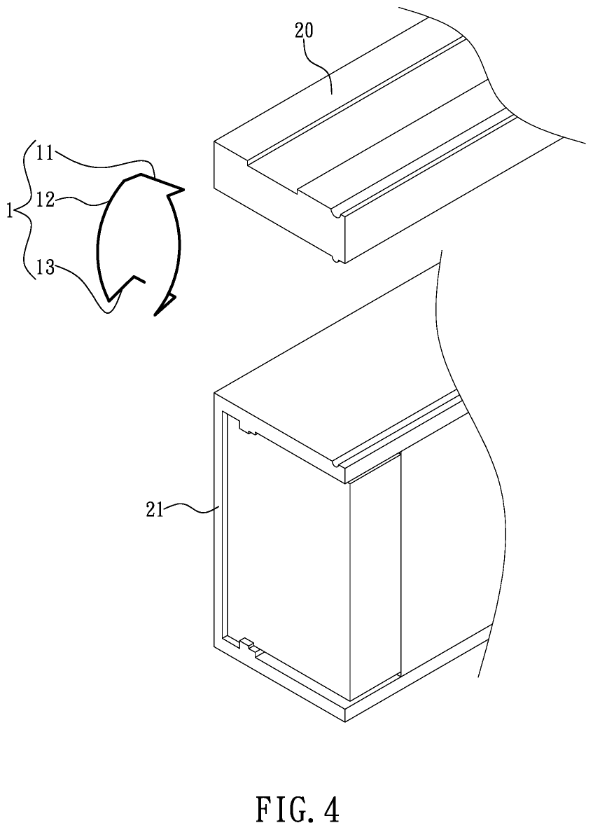

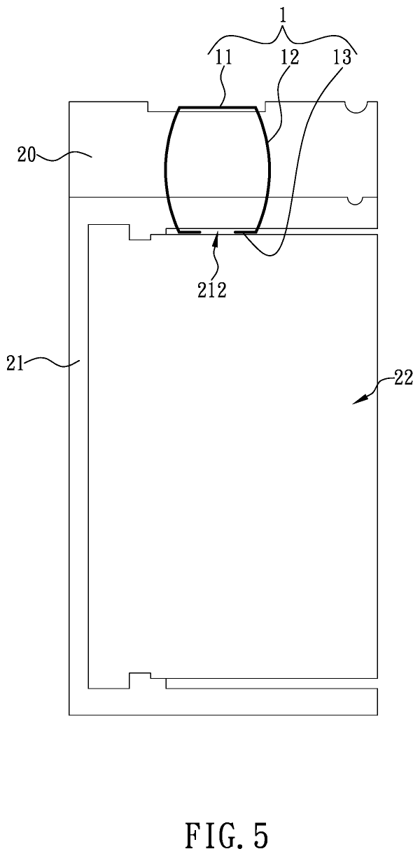

Referring to FIG. 4 and FIG. 5 in conjunction with FIG. 1, after the corresponding lateral sides of the positioning member 20 and the housing 21 are brought into abutment against each other, each clamp 1 is put in place to clamp an end edge of the positioning member 20 and the adjacent end edge of the housing 21 together, and thereby fix the positioning member 20 and the housing 21 to each other (see FIG. 5). In certain embodiments, each clamp 1 is formed by bending a metal wire (e.g., a steel wire) and includes a first bent portion 11, a connecting portion 12, and a second bent portion 13. The connecting portion 12 is located between the first bent portion 11 and the second bent portion 13. The first bent portion 11 is configured to abut against the opposite lateral side (hereinafter referred to as the second lateral side) of the positioning member 20, and the second bent portion 13 is configured to abut against an inner lateral side of the housing 21. In practice, the distance between the first bent portion 11 and the second bent portion 13 of each clamp 1, when the clamp 1 is not put in place to clamp the end edge of the positioning member 20 and the adjacent end edge of the housing 21, may be slightly smaller than a sum of the thicknesses of the adjacent end edges of the positioning member 20 and the housing 21, in order for the clamp 1 to hold the positioning member 20 and the housing 21 tightly together through the resilience of the clamp 1. Moreover, in certain embodiments, the inner lateral side of the housing 21 may be formed with a recessed portion 212 that faces the electromagnetic body 22, and a space defined by the recessed portion 212 and a lateral side of the electromagnetic body 22 that faces the recessed portion 212 is formed therebetween. The second bent portion 13 of each clamp 1 can extend into the space formed by the recessed portion 212 to better fix the positioning member 20 and the housing 21 together. Thus, even if an installing element between the housing 21 and the positioning member 20 breaks or is detached after long-term use, the clamp 1 can produce an additional or auxiliary fixing effect to help ensure the safety of use of the magnetic lock 2. If appropriate, the clamp 1 may serve directly as the major fixing structure for the housing 21 and the positioning member 20.

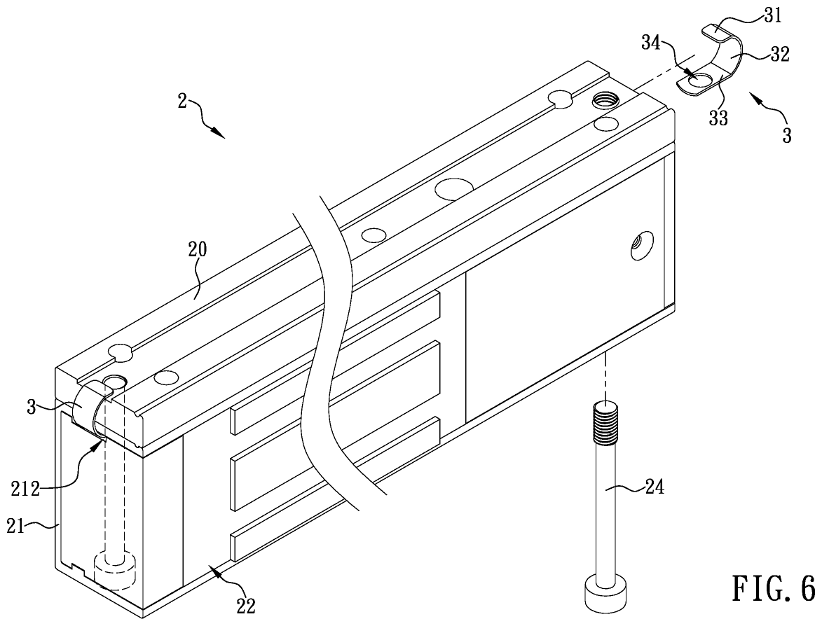

Referring to FIG. 6, clamps 3 are each formed by bending a metal plate, and each metal plate is bent into a shape of the letter “J”. However, the present disclosure is not limited thereto. Each clamp 3 includes a first bent portion 31, a connecting portion 32, and a second bent portion 33. The second bent portion 33 is formed with a through hole 34. After the first bent portion 31 and the second bent portion 33 of each clamp 3 are brought into abutment against the second lateral side of the positioning member 20 and the inner lateral side of the housing 21 (e.g., extending into the space formed by the recessed portion 212) respectively, a fixing rod 24 can be inserted sequentially through the housing 21, the electromagnetic body 22 and the through hole 34 of the clamp 3, and then fixed to the positioning member 20 (e.g., by threaded connection, mechanical engagement, or a tight fit). Thus, even if an installing element (e.g., at least one locking screw) between the housing 21 and the positioning member 20 becomes loose, the clamps 3 can keep the housing 21 from falling off. In terms of assembly, the housing 21 and the positioning member 20 can be clamped together by the clamps 3 in advance. Accordingly, the fixing rods 24 can be easily installed and precisely positioned, and the housing 21 is kept from moving away from its predetermined position while the fixing rods 24 are being locked. Consequently, the risk of the housing 21 falling off during installation, or after long-term use, of the magnetic lock 2 is reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A magnetic lock, comprising:
a housing provided with a receiving space therein;
an electromagnetic body configured to be assembled within the receiving space of the housing with a top surface of the electromagnetic body being exposed through the housing when the electromagnetic body is assembled within the receiving space, to receive externally supplied electricity, and to generate a magnetic attraction force on the top surface of the electromagnetic body;
a positioning member configured to be fixed on an object, and has a first lateral side configured to abut against an outer lateral side of the housing; and
at least one clamp configured to, when the first lateral side of the positioning member abuts against the outer lateral side of the housing, clamp together an end edge of the positioning member and an adjacent end edge of the housing to fix the positioning member and the housing together.

2. The magnetic lock according to claim 1, wherein the clamp is formed by bending a metal wire and comprises:
a first bent portion configured to, when the positioning member and the housing are clamped together by the clamp, abut against a second lateral side of the positioning member that is opposite to the first lateral side of the positioning member;
a second bent portion configured to, when the positioning member and the housing are clamped together by the clamp, abut against an inner lateral side of the housing; and
a connecting portion located between the first bent portion and the second bent portion.

3. The magnetic lock according to claim 1, wherein the clamp is formed by bending a metal plate and comprises a first bent portion configured to, when the positioning member and the housing are clamped together by the clamp, abut against a second lateral side of the positioning member that is opposite to the first lateral side of the positioning member; a second bent portion formed with a through hole and configured to, when the positioning member and the housing are clamped together by the clamp, abut against an inner lateral side of the housing; and a connecting portion located between the first bent portion and the second bent portion; and
wherein the magnetic lock further comprises at least one fixing rod configured to be inserted through the housing and the through hole and fixed to the positioning member.

4. The magnetic lock according to claim 3, wherein a length of the first bent portion is smaller than a length of the second bent portion.

5. The magnetic lock according to claim 4, wherein the fixing rod is fixed to the positioning member through a threaded connection.

6. The magnetic lock according to claim 2, wherein when the electromagnetic body is assembled within the receiving space, the inner lateral side of the housing has a recessed portion that faces the electromagnetic body, and a space is defined by and formed between the recessed portion and the electromagnetic body, and the second bent portion of the clamp is configured to extend into the space.

7. The magnetic lock according to claim 3, wherein when the electromagnetic body is assembled within the receiving space, the inner lateral side of the housing has a recessed portion that faces the electromagnetic body, and a space is defined by and formed between the recessed portion and the electromagnetic body, and the second bent portion of the clamp is configured to extend into the space.

8. The magnetic lock according to claim 4, wherein when the electromagnetic body is assembled within the receiving space, the inner lateral side of the housing has a recessed portion that faces the electromagnetic body, and a space is defined by and formed between the recessed portion and the electromagnetic body, and the second bent portion of the clamp is configured to extend into the space.

9. The magnetic lock according to claim 5, wherein when the electromagnetic body is assembled within the receiving space, the inner lateral side of the housing has a recessed portion that faces the electromagnetic body, and a space is defined by and formed between the recessed portion and the electromagnetic body, and the second bent portion of the clamp is configured to extend into the space.

10. The magnetic lock according to claim 6, wherein the electromagnetic body comprises an iron core and a coil, the iron core has an E-shaped cross section, and the coil is wound around a middle post of the iron core directly or indirectly, in order for the iron core to generate the magnetic attraction force when the coil is supplied with electricity.

11. The magnetic lock according to claim 7, wherein the electromagnetic body comprises an iron core and a coil, the iron core has an E-shaped cross section, and the coil is wound around a middle post of the iron core directly or indirectly, in order for the iron core to generate the magnetic attraction force when the coil is supplied with electricity.

12. The magnetic lock according to claim 8, wherein the electromagnetic body comprises an iron core and a coil, the iron core has an E-shaped cross section, and the coil is wound around a middle post of the iron core directly or indirectly, in order for the iron core to generate the magnetic attraction force when the coil is supplied with electricity.

13. The magnetic lock according to claim 9, wherein the electromagnetic body comprises an iron core and a coil, the iron core has an E-shaped cross section, and the coil is wound around a middle post of the iron core directly or indirectly, in order for the iron core to generate the magnetic attraction force when the coil is supplied with electricity.

14. The magnetic lock according to claim 10, wherein the iron core comprises a plurality of silicon steel plates, and the silicon steel plates are stacked upon each other to combine into a strip structure.

15. The magnetic lock according to claim 11, wherein the iron core comprises a plurality of silicon steel plates, and the silicon steel plates are stacked upon each other to combine into a strip structure.

16. The magnetic lock according to claim 12, wherein the iron core comprises a plurality of silicon steel plates, and the silicon steel plates are stacked upon each other to combine into a strip structure.

17. The magnetic lock according to claim 13, wherein the iron core comprises a plurality of silicon steel plates, and the silicon steel plates are stacked upon each other to combine into a strip structure.
